(19) United States
(12) Patent Application Publication
(10) Pub. No.: US 2009/0306797 A1
(43) Pub. Date: Dec. 10, 2009

(54) MUSIC ANALYSIS

(76) Inventors: Stephen Cox, Norwich (GB); Kris West, Surrey (GB)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/066,088

(22) PCT Filed: Sep. 8, 2006
(86) PCT No.: PCT/GB06/03324

§ 371 Date: Jul. 30, 2009

(30) Foreign Application Priority Data
Sep. 8, 2005 (GB) 0518401.5

(51) Int. Cl. G06F 17/00; G06N 5/02; G06F 17/30

(52) U.S. Cl. 700/94; 706/54; 707/E17.014; 707/E17.103; 707/6

(57) ABSTRACT

There is disclosed an analyser (101) for building a transcription model (112; 500) using a training database (111) of music. The analyser (101) decomposes the training music (111) into sound events (201a-e) and, in one embodiment, allocates the sound events to leaf nodes (504a-h) of a tree (500). There is also disclosed a transcriber (102) for transcribing music (121) into a transcript (113). The transcript (113) is sequence of symbols that represents the music (121), where each symbol is associated with a sound event in the music (121) being transcribed. In one embodiment, the transcriber (102) associates each of the sound events (201a-e) in the music (121) with a leaf node (504a-h) of a tree (500); in this embodiment the transcript (113) is a list of the leaf nodes (504a-h). The transcript (113) preserves information regarding the sequence of the sound events (201a-e) in the music (121) being transcribed.

The present invention is concerned with analysis of audio signals, for example music, and more particularly though not exclusively with the transcription of music.

Prior art approaches for transcribing music are generally based on a predefined notation such as Common Music Notation (CMN). Such approaches allow relatively simple music to be transcribed into a musical score that represents the transcribed music. Such approaches are not successful if the music to be transcribed exhibits excessive polyphony (simultaneous sounds) or if the music contains sounds (e.g. percussion or synthesizer sounds) that cannot readily be described using CMN.

According to the present invention, there is provided a transcriber for transcribing audio, an analyser and a player.

The present invention allows music to be transcribed, i.e. allows the sequence of sounds that make up a piece of music to be converted into a representation of the sequence of sounds. Many people are familiar with musical notation in which the pitch of notes of a piece of music are denoted by the values A-G. Although that is one type of transcription, the present invention is primarily concerned with a more general form of transcription in which portions of a piece of music are transcribed into sound events that have previously been encountered by a model.

Depending on the model, some of the sounds events may be transcribed to notes having values A-G. However, for some types of sounds (e.g. percussion instruments or noisy hissing types of sounds) such notes are inappropriate and thus the broader range of potential transcription symbols that is allowed by the present invention is preferred over the prior art CMN transcription symbols. The present invention does not use predefined transcription symbols. Instead, a model is trained using pieces of music and, as part of the training, the model establishes transcription symbols that are relevant to the music on which the model has been trained. Depending on the training music, some of the transcription symbols may correspond to several simultaneous sounds (e.g. a violin, a bag-pipe and a piano) and thus the present invention can operate successfully even when the music to be transcribed exhibits significant polyphony.

Transcriptions of two pieces of music may be used to compare the similarity of the two pieces of music. A transcription of a piece of music may also be used, in conjunction with a table of the sounds represented by the transcription, to efficiently code a piece of music and reduce the data rate necessary for representing the piece of music.

Some advantages of the present invention over prior art approaches for transcribing music are as follows:
These transcriptions can be used to retrieve examples based on queries formed of sub-sections of an example, without a significant loss of accuracy. This is a particularly useful property in Dance music as this approach can be used to retrieve examples that ‘quote’ small sections of another piece, such as remixes, samples or live performances.
Transcription symbols are created that represent what is unique about music in a particular context, while generic concepts/events will be represented by generic symbols. This allows the transcriptions to be tuned for a particular task as examples from a fine-grained context will produce more detailed transcriptions, e.g. it is not necessary to represent the degree of distortion of guitar sounds if the application is concerned with retrieving music from a database composed of Jazz and Classical pieces, whereas the key or intonation of trumpet sounds might be key to our ability to retrieve pieces from that database.
Transcriptions systems based on this approach implicitly take advantage of contextual information (which is a way of using metadata that more closely corresponds to human perception) than explicit operations on metadata labels, which: a) would have to be present particularly problematic for novel examples of music), b) are often imprecise or completely wrong, and c) only allow consideration of a single label or finite set of labels rather than similarity to or references from many styles of music. This last point is particularly important as instrumentation in a particular genre of music may be highly diverse and may ‘borrow’ from other styles, e.g. a Dance music piece may be particularly ‘jazzy’ and ‘quote’ a Reggae piece.
Transcriptions systems based on this approach produce an extremely compact representation of a piece that still contains a very rich detail. Conventional techniques either retain a huge quantity of information (with much redundancy) or compress features to a distribution over a whole example, losing nearly all of the sequential information and making queries that are based on sub-sections of a piece much harder to perform.
Systems based on transcriptions according to the present invention are easier to produce and update as the transcription system does not have to be retrained if a large quantity of novel examples are added, only the models trained on these transcriptions needs to be re-estimated, which is a significantly smaller problem than training a model directly on the Digital Signal Processing (DSP) data used to produce the transcription system. If stable, these transcription systems can even be applied to music from contexts that were not presented to the transcription system during training as the distribution and sequence of the symbols produced represents a very rich level of detail that is very hard to use with conventional DSP based approaches to the modelling of musical audio.
The invention can support multiple query types, including (but not limited to): artist identification, genre classification, example retrieval and similarity, playlist generation (i.e. selection of other pieces of music that are similar to a given piece of music, or selection of pieces of music that, considered together, vary gradually from genre to another genre), music key detection and tempo and rhythm estimation.
Embodiments of the invention allow the use of conventional text retrieval, classification and indexing techniques to be applied to music.
Embodiments of the invention may simplify rhythmic and melodic modelling of music and provide a more natural approach to these problems; this is because computationally insulating conventional rhythmic and melodic modelling techniques from complex DSP data significantly simplifies rhythmic and melodic modelling.
Embodiments of the invention may be used to support/inform transcription and source separation techniques, by helping to identify the context and instrumentation involved in a particular region of a piece of music.

### DESCRIPTION OF THE FIGURES

FIG. 1 shows an overview of a transcription system and shows, at a high level, (i) the creation of a model based on a classification tree, (ii) the model being used to transcribe a piece of music, and (iii) the transcription of a piece of music being used to reproduce the original music.

FIG. 2 shows the waveform versus time of a portion of a piece of music, and also shows segmentation of the waveform into sound events.

FIG. 3 shows a block diagram of a process for spectral feature contrast evaluation.

FIG. 4 shows a representation of the behaviour of a variety of processes that may be used to divide a piece of music into a sequence of sound events.

FIG. 5 shows a classification tree being used to transcribe sound events of the waveform of FIG. 2 by associating the sound events with appropriate transcription symbols.

FIG. 6 illustrates an iteration of a training process for the classification tree of FIG. 5.

FIG. 7 shows how decision parameters may be used to associate a sound event with the most appropriate sub-node of a classification tree.

FIG. 8 shows a classification tree of FIG. 3 being used to classify the genre of a piece of music.

FIG. 9 shows a neural net that may be used instead of the classification tree of FIG. 5 to analyse a piece of music.

FIG. 10 shows an overview of an alternative embodiment of a transcription system, with some features in common with FIG. 1.

FIG. 11 shows a block diagram of a process for evaluating Mel-frequency Spectral Irregularity coefficients. The process of FIG. 11 is used, in some embodiments, instead of the process of FIG. 3.

FIG. 12 shows a block diagram of a process for evaluating rhythm-cepstrum coefficients. The process of FIG. 12 is used, in some embodiments, instead of the process of FIG. 3.

### DESCRIPTION OF PREFERRED EMBODIMENTS

As those skilled in the art will appreciate, a detailed discussion of portions of an embodiment of the present invention is provided at Annexe 1 “FINDING AN OPTIMAL SEGMENTATION FOR AUDIO GENRE CLASSIFICATION”. Annexe 1 formed part of the priority application, from which the present application claims priority. Annexe 1 also forms part of the present application. Annexe 1 was unpublished at the date of filing of the priority application.

A detailed discussion of portions of embodiments of the present invention is also provided at Annexe 2 “Incorporating Machine-Learning into Music Similarity Estimation”. Annexe 2 forms part of the present application. Annexe 2 is unpublished as of the date of filing of the present application.

A detailed discussion of portions of embodiments of the present application is also provided at Annexe 3 “A MODEL-BASED APPROACH TO CONSTRUCTING MUSIC SIMILARITY FUNCTIONS”. Annexe 3 forms part of the present application. Annexe 3 is unpublished as of the date of filing of the present application.

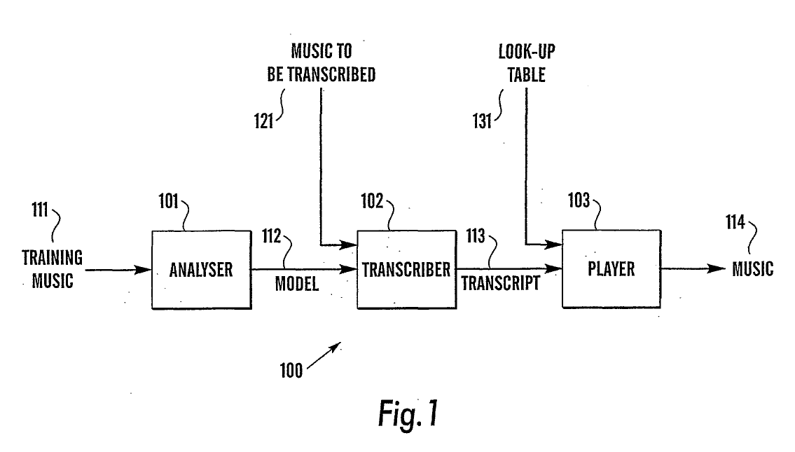

FIG. 1 shows an overview of a transcription system 100 and shows an analyser 101 that analyses a training music library 111 of different pieces of music. The music library 111 is preferably digital data representing the pieces of music. The training music library 111 in this embodiment comprises 1000 different pieces of music comprising genres such as Jazz, Classical, Rock and Dance. In this embodiment, ten genres are used and each piece of music in the training music library 111 comprises data specifying the particular genre of its associated piece of music.

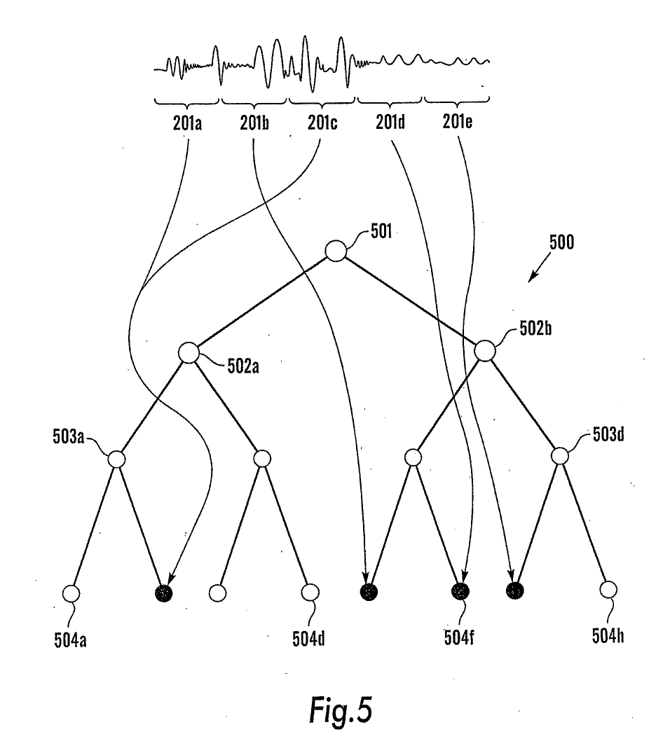

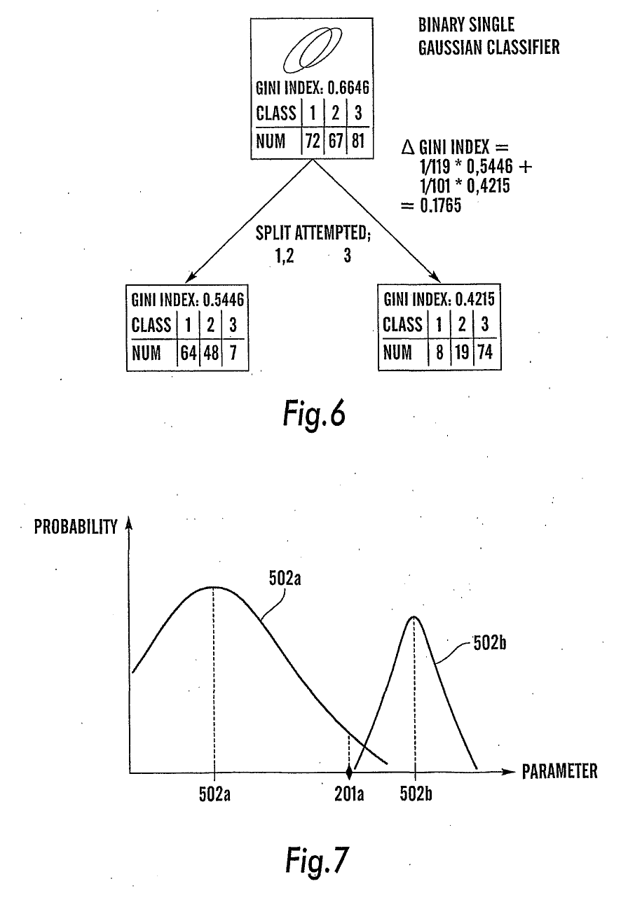

The analyser 101 analyses the training music library 111 to produce a model 112. The model 112 comprises data that specifies a classification tree (see FIGS. 5 and 6). Coefficients of the model 112 are adjusted by the analyser 101 so that the model 112 successfully distinguishes sound events of the pieces of music in the training music library 111. In this embodiment the analyser 101 uses the data regarding the genre of each piece of music to guide the generation of the model 112.

A transcriber 102 uses the model 112 to transcribe a piece of music 121 that is to be transcribed. The music 121 is preferably in digital form. The music 121 does not need to have associated data identifying the genre of the music 121. The transcriber 102 analyses the music 121 to determine sound events in the music 121 that correspond to sound events in the model 112. Sound events are distinct portions of the music 121. For example, a portion of the music 121 in which a trumpet sound of a particular pitch, loudness, duration and timbre is dominant may form one sound event. Another sound event may be a portion of the music 121 in which a guitar sound of a particular pitch, loudness, duration and timbre is dominant. The output of the transcriber 102 is a transcription 113 of the music 121, decomposed into sound events.

A player 103 uses the transcription 113 in conjunction with a look-up table (LUT) 131 of sound events to reproduce the music 121 as reproduced music 114. The transcription 113 specifies a sub-set of the sound events classified by the model 112. To reproduce the music 121 as music 114, the sound events of the transcription 113 are played in the appropriate sequence, for example piano of pitch G#, “loud”, for 0.2 seconds, followed by flute of pitch B, 10 decibels quieter than the piano, for 0.3 seconds. As those skilled in the art will appreciate, in alternative embodiments the LUT 131 may be replaced with a synthesiser to synthesise the sound events.

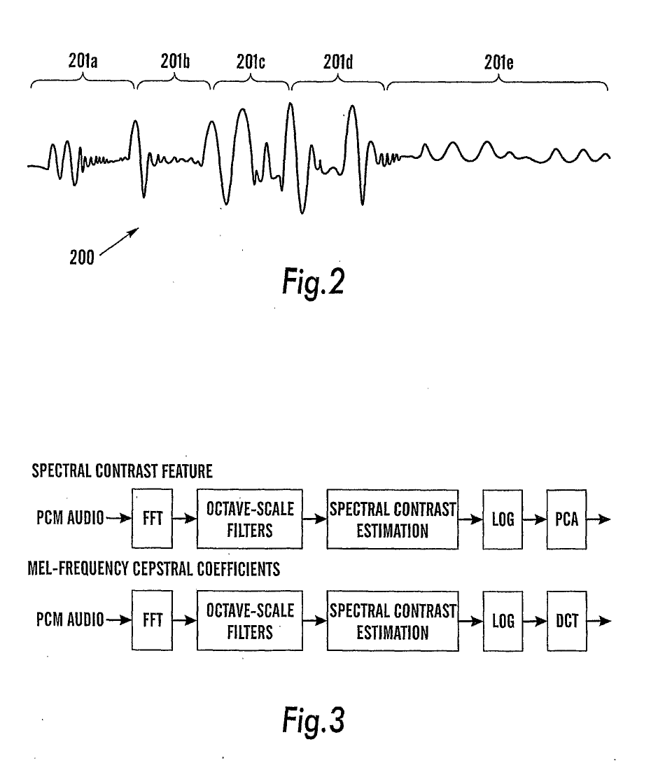

FIG. 2 shows a waveform 200 of part of the music 121. As can be seen, the waveform 200 has been divided into sound events 201a-201e. Although by visual inspection sound events 201c and 201d appear similar, they represent different sounds and thus are determined to be different events.

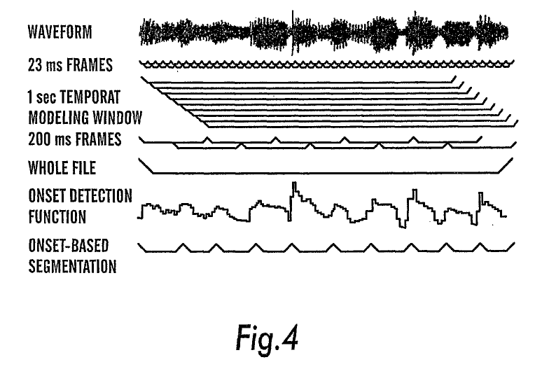

FIGS. 3 and 4 illustrate the way in which the training music library 111 and the music 121 are divided into sound events 201.

FIG. 3 shows that incoming audio is first divided into frequency bands by a Fast Fourier Transform (FFT) and then the frequency bands are passed through either octave or mel filters. As those skilled in the art will appreciate, mel filters are based on the mel scale which more closely corresponds to humans' perception of pitch than frequency. The spectral contrast estimation of FIG. 3 compensates for the fact that a pure tone will have a higher peak after the FFT and filtering than a noise source of equivalent power (this is because the energy of the noise source is distributed over the frequency/mel band that is being considered rather than being concentrated as for a tone).

FIG. 4 shows that the incoming audio may be divided into 23 millisecond frames and then analysed using a 1 s sliding window. An onset detection function is used to determine boundaries between adjacent sound events. As those skilled in the art will appreciate, further details of the analysis may be found in Annex 1. Note that FIG. 4 of Annex 1 shows that sound events may have different durations.

FIG. 5 shows the way in which the transcriber 102 allocates the sound events of the music 121 to the appropriate node of a classification tree 500. The classification tree 500 comprises a root node 501 which corresponds to all the sounds events that the analyser 101 encountered during analysis of the training music 111. The root node 501 has sub-nodes 502a, 502b. The sub-nodes 502 have further sub-nodes 503a-d and 504a-h. In this embodiment, the classification tree 500 is symmetrical though, as those skilled in the art will appreciate, the shape of the classification tree 500 may also be asymmetrical (in which case, for example, the left hand side of the classification tree may have more leaf nodes and more levels of sub-nodes than the right hand side of the classification tree).

Note that neither the root node 501 nor the other nodes of the classification tree 500 actually stores the sound events. Rather, the nodes of the tree correspond to subsets of all the sound events encountered during training. The root node 500 corresponds with all sound events. In this embodiment, the node 502b corresponds with sound events that are primarily associated with music of the Jazz genre. The node 502a corresponds with sound events of genres other than Jazz (i.e. Dance, Classical, Hip-hop etc). Node 503b corresponds with sound events that are primarily associated with the Rock genre. Node 503a corresponds with sound events that are primarily associated with genres other than Classical and Jazz. Although for simplicity the classification tree 500 is shown as having a total of eight leaf nodes (here, the nodes 504a-h are the leaf nodes), in some embodiments the classification tree may have in the region of 3,000 to 10,000 leaf nodes, where each leaf node corresponds to a distinct sound event.

Not shown, but associated with the classification tree 500, is information that is used to classify a sound event. This information is discussed in relation to FIG. 6.

As shown, the sound events 201a-e are mapped by the transcriber 102 to leaf nodes 504b, 504e, 504b, 504f, 504g, respectively. Leaf nodes 504b, 504e, 504f and 504g have been filled in to indicate that these leaf nodes correspond to sound events in the music 121. The leaf nodes 504a, 504c, 504d, 504h are hollow to indicate that the music 121 did not contain any sound events corresponding to these leaf nodes. As can be seen, sound events 201a and 201c both map to leaf node 504b which indicates that, as far as the transcriber 102 is concerned, the sound events 201a and 201c are identical. The sequence 504b, 504e, 504b, 504f, 504g is a transcription of the music 121.

FIG. 6 illustrates an iteration of a training process during which the classification tree 500 is generated, and thus illustrates the way in which the analyser 101 is trained by using the training music 111.

Initially, once the training music 111 has been divided into sound events, the analyser 101 has a set of sound events that are deemed to be associated with the root node 501. Depending on the size of the training music 111, the analyser 101 may, for example, have a set of one million sound events. The problem faced by the analyser 101 is that of recursively dividing the sound events into sub-groups; the number of sub-groups (i.e. sub-nodes and leaf nodes) needs to be sufficiently large in order to distinguish dissimilar sound events while being sufficiently small to group together similar sound events (a classification tree having one million leaf nodes would be computationally unwieldy).

FIG. 6 shows an initial split by which some of the sound events from the root node 501 are associated with the sub-node 502a while the remaining sound events from the root node 501 are associated with the sub-node 502b. As those skilled in the art will appreciate, there a number of different criteria available for evaluating the success of a split. In this embodiment the Gini index of diversity is used, see Annex 1 for further details.

FIG. 6 illustrates the initial split by considering, for simplicity, three classes (the training music 111 is actually divided into ten genres) with a total of 220 sound events (the actual training music may typically have a million sound events). The Gini criterion attempts to separate out one genre from the other genres, for example Jazz from the other genres. As shown, the split attempted at FIG. 6 is that of separating class 3 (which contains 81 sound events) from classes 1 and 2 (which contain 72 and 67 sound events, respectively). In other words, 81 of the sound events of the training music 111 come from pieces of music that have been labelled as being of the Jazz genre.

After the split, the majority of the sound events belonging to classes 1 and 2 have been associated with sub-node 502a while the majority of the sound events belonging to class 3 have been associated with sub-node 502b. In general, it is not possible to “cleanly” (i.e. with no contamination) separate the sound events of classes 1, 2 and 3. This because there may be, for example, some relatively rare sound events in Rock that are almost identical to sound events that are particularly common in Jazz; thus even though the sound events may have come from Rock, it makes sense to group those Rock sound events with their almost identical Jazz counterparts.

In this embodiment, each sound event 201 comprises a total of 129 parameters. For each of 32 mel-scale filter bands, the sound event 201 has both a spectral level parameter (indicating the sound energy in the filter band) and a pitched/noisy parameter, giving a total of 64 basic parameters. The pitched/noisy parameters indicate whether the sound energy in each filter band is pure (e.g. a sine wave) or is noisy (e.g. sibilance or hiss). Rather than simply having 64 basic parameters, in this embodiment the mean over the sound event 201 and the variance during the sound event 201 of each of the basic parameters is stored, giving 128 parameters. Finally, the sound event 201 also has duration, giving the total of 129 parameters.

The transcription process of FIG. 5 will now be discussed in terms of the 129 parameters of the sound event 201a. The first decision that the transcriber 102 must make for sound event 201a is whether to associate sound event 201a with sub-node 502a or sub-node 502b. In this embodiment, the training process of FIG. 6 results in a total of 516 decision parameters for each split from a parent node to two sub-nodes.

The reason why there are 516 decision parameters is that each of the sub-nodes 502a and 502b has 129 parameters for its mean and 129 parameters describing its variance. This is illustrated by FIG. 7. FIG. 7 shows the mean of sub-node 502a as a point along a parameter axis. Of course, there are actually 129 parameters for the mean sub-node 502a but for convenience these are shown as a single parameter axis. FIG. 7 also shows a curve illustrating the variance associated with the 129 parameters of sub-node 502a. Of course, there are actually a total of 129 parameters associated with the variance of sub-node 502a but for convenience the variance is shown as a single curve. Similarly, sub-node 502b has 129 parameters for its mean and 129 parameters associated with its variance, giving a total of 516 decision parameters for the split between sub-nodes 502a and 502b.

Given the sound event 201a, FIG. 7 shows that although the sound event 201a is nearer to the mean of sub-node 502b than the mean of sub-node 502a, the variance of the sub-node 502b is so small that the sound event 201a is more appropriately associated with sub-node 502a than the sub-node 502b.

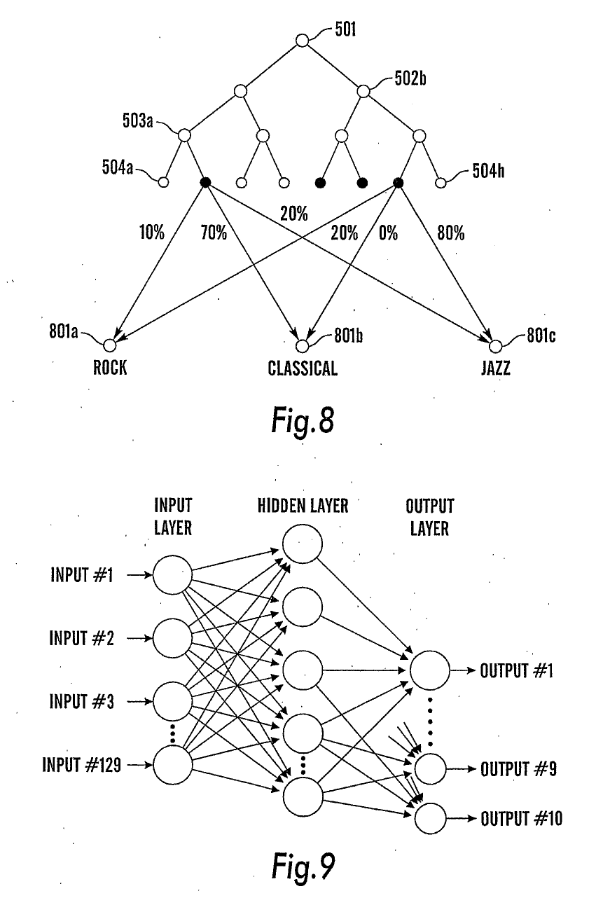

FIG. 8 shows the classification tree of FIG. 3 being used to classify the genre of a piece of music. Compared to FIG. 3, FIG. 8 additionally comprises nodes 801a, 801b and 801b. Here, node 801a indicates Rock, node 801b Classical and node 801c Jazz. For simplicity, nodes for the other genres are not shown by FIG. 8.

Each of the nodes 801 assesses the leaf nodes 504 with a predetermined weighting. The predetermined weighting may be established by the analyser 101. As shown, leaf node 504b is weighted as 10% Rock, 70% Classical and 20% Jazz. Leaf node 504g is weighted as 20% Rock, 0% Classical and 80% Jazz. Thus once a piece of music has been transcribed into its constituent sound events, the weights of the leaf nodes 504 may be evaluated to assess the probability of the piece of music being of the genre Rock, Classical or Jazz (or one of the other seven genres not shown in FIG. 8). Those skilled in the art will appreciate that there may be prior art genre classification systems that have some features in common with those depicted in FIG. 8.

However a difference between such prior art systems and the present invention is that the present invention regards the association between sound events and the leaf nodes 504 as a transcription of the piece of music. In contrast, in such prior art systems the leaf nodes 504 are not directly used as outputs (i.e. as sequence information) but only as weights for the nodes 801. Thus such systems do not take advantage of the information that is available at the leaf nodes 504 once the sound events of a piece of music have been associated with respective leaf nodes 504. Put another way, such prior art systems discard temporal information associated with the decomposition of music into sound events; the present invention retains temporal information associated with the sequence of sound events in music (FIG. 5 shows that the sequence of sound events 201a-e is transcribed into the sequence 504b, 504e, 504b, 504f, 504g).

FIG. 9 shows an embodiment in which the classification tree 500 is replaced with a neural net 900. In this embodiment, the input layer of the neural net comprises 129 nodes, i.e. one node for each of the 129 parameters of the sound events. FIG. 9 shows a neural net 900 with a single hidden layer. As those skilled in the art will appreciate, some embodiments using a neural net may have multiple hidden layers. The number of nodes in the hidden layer of neural net 900 will depend on the analyser 101 but may range from, for example, about eighty to a few hundred.

FIG. 9 also shows an output layer of, in this case, ten nodes, i.e. one node for each genre. Prior art approaches for classifying the genre of a piece of music have taken the outputs of the ten neurons of the output layer as the output.

In contrast, the present invention uses the outputs of the nodes of the hidden layer as outputs. Once the neural net 900 has been trained, the neural net 900 may be used to classify and transcribe pieces of music. For each sound event 201 that is inputted to the neural net 900, a particular sub-set of the nodes of the hidden layer will fire (i.e. exceed their activation threshold). Thus whereas for the classification tree 500 a sound event 201 was associated with a particular leaf node 504, here a sound event 201 is associated with a particular pattern of activated hidden nodes. To transcribe a piece of music, the sound events 201 of that piece of music are sequentially inputted into the neural net 900 and the patterns of activated hidden layer nodes are interpreted as codewords, where each codeword designate a particular sound event 201 (of course, very similar sound events 201 will be interpreted by the neural net 900 as identical and thus will have the same pattern of activation of the hidden layer).

An alternative embodiment (not shown) uses clustering, in this case K-means clustering, instead of the classification tree 500 or the neural net 900. The embodiment may use a few hundred to a few thousand cluster centres to classify the sound events 201. A difference between this embodiment and the use of the classification tree 500 or neural net 900 is that the classification tree 500 and the neural net 900 require supervised training whereas the present embodiment does not require supervision. By unsupervised training, it is meant that the pieces of music that make up the training music 111 do not need to be labelled with data indicating their respective genres. The cluster model may be trained by randomly assigning cluster centres. Each cluster centre has an associated distance, sound events 201 that lie within the distance of a cluster centre are deemed to belong to that cluster centre. One or more iterations may then be performed in which each cluster centre is moved to the centre of its associated sound events; the moving of the cluster centres may cause some sound events 201 to lose their association with the previous cluster centre and instead be associated with a different cluster centre. Once the model has been trained and the centres of the cluster centres have been established, sound events 201 of a piece of music to be transcribed are inputted to the K-means model. The output is a list of the cluster centres with which the sound events 201 are most closely associated. The output may simply be an un-ordered list of the cluster centres or may be an ordered list in which sound event 201 is transcribed to its respective cluster centre. As those skilled in the art will appreciate, cluster models have been used for genre classification. However, the present embodiment (and the embodiments based on the classification tree 500 and the neural net 900) uses the internal structure of the model as outputs rather than what are conventionally used as outputs. Using the outputs from the internal structure of the model allows transcription to be performed using the model.

The transcriber 102 described above decomposed a piece of audio or music into a sequence of sound events 201. In alternative embodiments, instead of the decomposition being performed by the transcriber 201, the decomposition may be performed by a separate processor (not shown) which provides the transcriber with sound events 201. In other embodiments, the transcriber 102 or the processor may operate on Musical Instrument Digital Interface (MIDI) encoded audio to produce a sequence of sound events 201.

The classification tree 500 described above was a binary tree as each non-leaf node had two sub-nodes. As those skilled in the art will appreciate, in alternative embodiments a classification tree may be used in which a non-leaf node has three or more sub-nodes.

The transcriber 102 described above comprised memory storing information defining the classification tree 500. In alternative embodiments, the transcriber 102 does not store the model (in this case the classification tree 500) but instead is able to access a remotely stored model. For example, the model may be stored on a computer that is linked to the transcriber via the Internet.

As those skilled in the art will appreciate, the analyser 101, transcriber 102 and player 103 may be implanted using computers or using electronic circuitry. If implemented using electronic circuitry then dedicated hardware may be used or semi-dedicated hardware such as Field Programmable Gate Arrays (FPGAs) may be used.

Although the training music 111 used to generate the classification tree 500 and the neural net 900 were described as being labelled with data indicating the respective genres of the pieces of music making up the training music 111, in alternative embodiments other labels may be used. For example, the pieces of music may be labelled with “mood”, for example whether a piece of music sounds “cheerful”, “frightening” or “relaxing”.

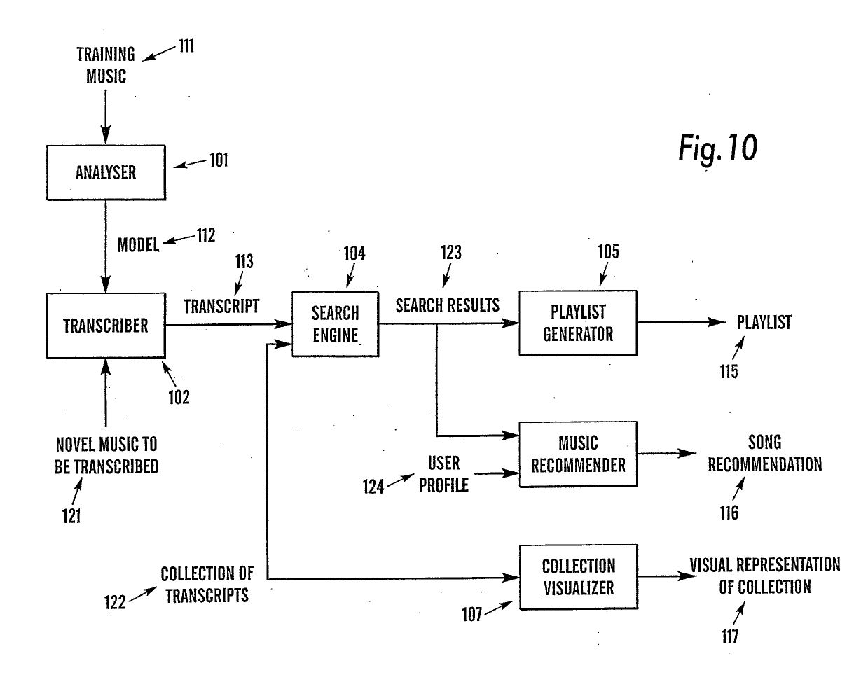

FIG. 10 shows an overview of a transcription system 100 similar to that of FIG. 1 and again shows an analyser 101 that analyses a training music library 111 of different pieces of music. The training music library 111 in this embodiment comprises 5000 different pieces of music comprising genres such as Jazz, Classical, Rock and Dance. In this embodiment, ten genres are used and each piece of music in the training music library 111 comprises data specifying the particular genre of its associated piece of music.

The analyser 101 analyses the training music library 111 to produce a model 112. The model 112 comprises data that specifies a classification tree. Coefficients of the model 112 are adjusted by the analyser 101 so that the model 112 successfully distinguishes sound events of the pieces of music in the training music library 111. In this embodiment the analyser 101 uses the data regarding the genre of each piece of music to guide the generation of the model 112, but any suitable label set may be substituted (e.g. mood, style, instrumentation).

A transcriber 102 uses the model 112 to transcribe a piece of music 121 that is to be transcribed. The music 121 is preferably in digital form. The transcriber 102 analyses the music 121 to determine sound events in the music 121 that correspond to sound events in the model 112. Sound events are distinct portions of the music 121. For example, a portion of the music 121 in which a trumpet sound of a particular pitch, loudness, duration and timbre is dominant may form one sound event. In an alternative embodiment, based on the timing of events, a particular rhythm might be dominant. The output of the transcriber 102 is a transcription 113 of the music 121, decomposed into labelled sound events.

A search engine 104 compares the transcription 113 to a collection of transcriptions 122, representing a collection of music recordings, using standard text search techniques, such as the Vector model with TF/IDF weights. In a basic Vector model text search, the transcription is converted into a fixed size set of term weights and compared with the Cosine distance. The weight for each term tᵢ can be produced by simple term frequency (TF), as given by:

$$tf = \frac{{n}_{i}}{{\sum }_{k} {n}_{k} }$$

where nᵢ is the number of occurrences of each term, or term frequency-inverse document frequency (TF/IDF), as given by:

$$idf = log \frac{\vert D \vert}{\vert ( {d}_{i} ⊃ {t}_{i} ) \vert}$$

$$tfidf = tf \cdot idf$$

Where |D| is the number of documents in the collection and |(dᵢ⊃tᵢ)| is the number of documents containing term tᵢ. (Readers unfamiliar with vector based text retrieval methods should see Modern Information Retrieval by R. Baeza-Yates and B. Ribeiro-Neto (Addison-Wesley Publishing Company, 1999) for an explanation of these terms.) In the embodiment of FIG. 10 the ‘terms’ are the leaf node identifiers and the ‘documents’ are the songs in the database. Once the weights vector for each document has been extracted, the degree of similarity of two documents can be estimated with, for example, the Cosine distance. This search can be further enhanced by also extracting TF or TF/IDF weights for pairs or triple of symbols found in the transcriptions, which are known as bi-grams or tri-grams respectively and comparing those. The use of weights for bi-grams or tri-grams of the symbols in the search allows it consider the ordering of symbols as well as their frequency of appearance, thereby increasing the expressive power of the search. As those skilled in the art will appreciate, bi-grams and tri-grams are particular cases of n-grams. Higher order (e.g. n=4) grams may be used in alternative embodiments. Further information may be found at Annexe 2, particularly at section 4.2 of Annexe 2. As those skilled in the art will also appreciate, FIG. 4 of Annexe 2 shows a tree that is in some ways similar to the classification tree 500 of FIG. 5. The tree of FIG. 4 of Annexe 2 is shown being used to analyse a sequence of six sound events into the sequence ABABCC, where A, B and C each represent respective leaf nodes of the tree of FIG. 4 of Annexe 2.

Each item in the collection 122 is assigned a similarity score to the query transcription 113 which can be used to return a ranked list of search results 123 to a user. Alternatively, the similarity scores 123 may be passed to a playlist generator 105, which will produce a playlist 115 of similar music, or a Music recommendation script 106, which will generate purchase song recommendations by comparing the list of similar songs to the list of songs a user already owns 124 and returning songs that were similar but not in the user's collection 116. Finally, the collection of transcriptions 122 may be used to produce a visual representation of the collection 117 using standard text clustering techniques.

FIG. 8 showed nodes 801 being used to classify the genre of a piece of music. FIG. 2 of Annexe 2 shows an alternative embodiment in which the logarithm of likelihoods is summed for each sound event in a sequence of six sound events. FIG. 2 of Annexe 2 shows gray scales in which for each leaf node, the darkness of the gray is proportional to the probability of the leaf node belonging to one of the following genres: Rock, Classical and Electronic. The leftmost leaf node of FIG. 2 of Annexe 2 has the following probabilities: Rock 0.08, Classical 0.01 and Electronic 0.91. Thus sound events associated with the leftmost leaf node are deemed to be indicative of music in the Electronic genre.

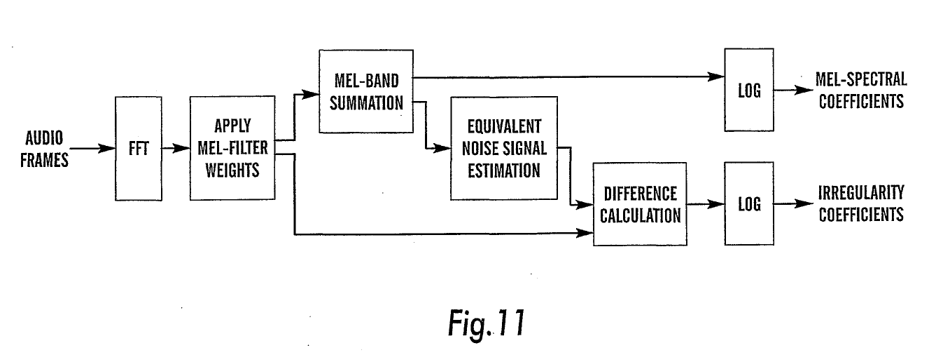

FIG. 11 shows a block diagram of a process for evaluating Mel-frequency Spectral Irregularity coefficients. The process of FIG. 11 may be used, in some embodiments, instead of the process of FIG. 3. Any suitable numerical representation of the audio may be used as input to the analyser 101 and transcriber 102. One such alternative to the MFCCs and the Spectral Contrast features already described are Mel-frequency Spectral Irregularity coefficients (MFSIs). FIG. 11 illustrates the calculation of MFSIs and shows that incoming audio is again divided into frequency bands by a Fast Fourier Transform (FFT) and then the frequency bands are passed through either a Mel-frequency scale filter-bank. The mel-filter coefficients are collected and the white-noise signal that would have yielded the same coefficient is estimated for each band of the filter-bank. The difference between this signal and the actual signal passed through the filter-bank band is calculated and the log taken. The result is termed the irregularity coefficient. Both the log of the mel-filter and irregularity coefficients form the final MFSI features. The spectral irregularity coefficients compensate for the fact that a pure tone will exhibit highly localised energy in the FFT bands and is easily differentiated from a noise signal of equivalent strength, but after passing the signal through a mel-scale filter-bank much of this information may have been lost and the signals may exhibit similar characteristics. Further information on FIG. 11 may be found in Annexe 2 (see the description in Annexe 2 of FIG. 1 of Annexe 2).

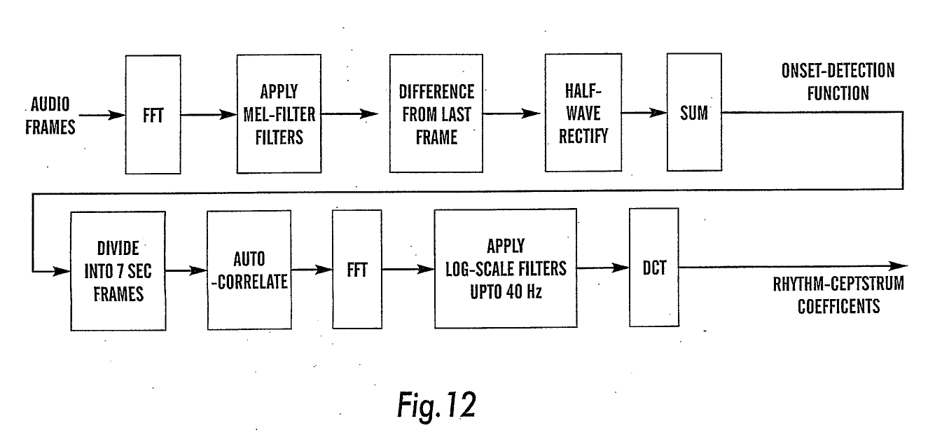

FIG. 12 shows a block diagram of a process for evaluating rhythm-cepstrum coefficients. The process of FIG. 12 is used, in some embodiments, instead of the process of FIG. 3. FIG. 12 shows that incoming audio is analysed by an onset-detection function by passing the audio through a FFT and mel-scale filter-bank. The difference between concurrent frames filter-bank coefficients is calculated and the positive differences are summed to produce a frame of the onset detection function. Seven second sequences of the detection function are autocorrelated and passed through another FFT to extract the Power spectral density of the sequence, which describes the frequencies of repetition in the detection function and ultimately the rhythm in the music. A Discrete Cosine transform of these coefficients is calculated to describe the ‘shape’ of the rhythm—irrespective of the tempo at which it is played. The rhythm-cepstrum analysis has been found to be particularly effective for transcribing Dance music.

Embodiments of the present application have been described for transcribing music. As those skilled in the art will appreciate, embodiments may also be used for analysing other types of signals, for example birdsongs.

Embodiments of the present application may be used in devices such as, for example, portable music players (e.g. those using solid state memory or miniature hard disk drives, including mobile phones) to generate play lists. Once a user has selected a particular song, the device searches for songs that are similar to the genre/mood of the selected song.

Embodiments of the present invention may also be used in applications such as, for example, on-line music distribution systems. In such systems, users typically purchase music. Embodiments of the present invention allow a user to indicate to the on-line distribution system a song that the user likes. The system then, based on the characteristics of that song, suggests similar songs to the user. If the user likes one or more of the suggested songs then the user may purchase the similar song(s).

1. An apparatus for transcribing a signal, for example a signal representing music, comprising:
means for receiving data representing sound events;
means for accessing a model, wherein the model comprises transcription symbols and wherein the model also comprises decision criteria for associating a sound event with a transcription symbol;
means for using the decision criteria to associate the sound events with the appropriate transcription symbols; and
means for outputting a transcription of the sound events, wherein the transcription comprises a list of transcription symbols.

2. An apparatus according to claim 1, wherein the means for accessing a model is operable to access a classification tree, and wherein the means for using the decision criteria is operable to associate sound events with leaf nodes of the classification tree.

3. An apparatus according to claim 1, wherein the means for accessing a model is operable to access a neural net, and wherein the means for using the decision criteria is operable to associate sound events with a patterns of activated nodes.

4. An apparatus according to claim 1, wherein the means for accessing a model is operable to access a cluster model, and wherein the means for using the decision criteria is operable to associate sound events with cluster centres.

5. An apparatus according to any claim 1, wherein the means for outputting a transcription is operable to provide a sequence of transcription symbols that corresponds to the sequence of the sound events.

6. An apparatus according to claim 1, comprising the model.

7. An apparatus according to claim 1, comprising means for decomposing music into sound events.

8. An apparatus according to claim 7, comprising means for dividing music into frames, and comprising onset detection means for determining sound events from the frames.

9. An analyser for producing a model, comprising:
means for receiving information representing sound events;
means for processing the sound events to determine transcription symbols and to determine decision criteria for associating sound events with transcription symbols; and
means for outputting the model.

10. An analyser according to claim 9, wherein the means for receiving sound events is operable to receive label information, and wherein the means for processing is operable to use the label information to determine the transcription symbols and the decision criteria.

11. (canceled)

12. (canceled)

13. (canceled)

14. (canceled)

15. An on-line music distribution system comprising an apparatus according to claim 1.

16. A method of transcribing music, comprising the steps of:
receiving data representing sound events;
accessing a model, wherein the model comprises transcription symbols and wherein the model also comprises decision criteria for associating a sound event with a transcription symbol;
using the decision criteria to associate the sound events with the appropriate transcription symbols; and
outputting a transcription of the sound events, wherein the transcription comprises a list of transcription symbols.

17. A method of producing a model for transcribing music, comprising the steps of:
receiving information representing sound events;
processing the sound events to determine transcription symbols and to determine decision criteria for associating sound events with transcription symbols; and
outputting the model.

18. A computer program product defining processor interpretable instructions for instructing a processor to perform the method of claim 16.

19. A method of comparing a first audio signal with a second audio signal, the method comprising the steps of:
receiving first information representing the first audio signal by receiving a first audio signal and preparing the first information from the first audio signal, wherein the first information comprises a transcription of sound events in the first audio signal, the first information being prepared from the first audio signal by performing the steps of:
receiving data representing the sound events;
accessing a model, wherein the model comprises transcription symbols and wherein the model also comprises decision criteria for associating a sound event with a transcription symbol;
using the decision criteria to associate the sound events with the appropriate transcription symbols; and
outputting a transcription of the sound events, wherein the transcription comprises a list of transcription symbols;
receiving second information representing the second audio signal, wherein the second information comprises a transcription of sound events in the second audio signal; and
using a text search technique to compare the first information with the second information in order to determine the similarity between the first audio signal and the second audio signal.

20. A method according to claim 19, wherein the step of using a text search technique comprises using a vector model text search technique.

21. A method according to claim 19, wherein the step of using a text search technique comprises using TF weights.

22. A method according to claim 19, wherein the step of using a text search technique comprises using TF/IDF weights.

23. A method according to any one of claims 19, wherein the step of using a text search technique comprises the step of using n-grams.

24. A method according to claim 23, wherein the step of using n-grams comprises using bi-grams.

25. (canceled)

26. A method according to any one of claims 19, wherein the step of receiving second information comprises the steps of:
receiving a second audio signal; and
preparing the second information from the second audio signal using a method comprising the steps of:
receiving data representing sound events;
accessing a model, wherein the model comprises transcription symbols and wherein the model also comprises decision criteria for associating a sound event with a transcription symbol;
using the decision criteria to associate the sound events with the appropriate transcription symbols; and
outputting a transcription of the sound events, wherein the transcription comprises a list of transcription symbols.

27. An apparatus for comparing a first audio signal with a second audio signal, the apparatus comprising:
means for receiving first information representing the first audio signal, wherein the first information comprises a transcription of sound events in the first audio signal;
means for receiving second information representing the second audio signal, wherein the second information comprises a transcription of sound events in the second audio signal; and
means for using a text search technique to compare the first information with the second information in order to determine the similarity between the first audio signal and the second audio signal.
